(19) United States
(12) Patent Application Publication
(10) Pub. No.: US 2007/0022142 A1
(43) Pub. Date: Jan. 25, 2007

(54) System and method to generate domain knowledge for automated system management by combining designer specifications with data mining activity

(75) Inventors: John D. Palmer, San Jose, CA (US); Sandeep M. Uttamchandani, San Jose, CA (US); Xiaoxin Yin, Champaign, IL (US)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(73) Assignee: International Business Machines Corporation, Armonk, NY (US)

(21) Appl. No.: 11/185,645

(22) Filed: Jul. 20, 2005

(51) Int. Cl. G06F 17/30

(52) U.S. Cl. 707/200

(57) ABSTRACT

A system and method of creating domain knowledge-base models required for automated system management, wherein the method comprises defining data storage system designer specifications comprising input/output parameters; analyzing a runtime system performance log of a data storage system; identifying relationship functions between different ones of the input/output parameters; deriving knowledge-base models from the designer specifications, the runtime system performance log, and the relationship functions; refining the knowledge-base models at system runtime using newly monitored system performance logs; and improving the accuracy of the knowledge-base models by detecting incomplete designer specifications, wherein the knowledge-base models are preferably generated by data mining techniques.

### BACKGROUND

1. Field of the Invention

The embodiments of the invention generally relate to storage systems and, more particularly, for creating the domain knowledge-base for automation of run-time system management.

2. Description of the Related Art

System management is typically driven by human administrators that continuously monitor the system, analyze its behavior, and take corrective actions to ensure that it converges towards desired threshold goals for performance, availability, security, etc. With the cost of system management becoming a significant percentage of the Total Cost of Ownership (TOC), self-management has essentially become a necessity. The idea of self-management is well-known in the art. Expert systems have been used to automate various human-intensive processes such as disease diagnosis, fault analysis, etc. An important lesson learned by deploying expert systems is summarized by the well-known Knowledge Principle: “The power of artificial intelligence programs (i.e., expert systems) to perform at high levels of competence is primarily a function of the program's knowledge of its task domain, and not of the program's reasoning processes.” In other words, the effectiveness of an automated system is dependent on the “richness” of domain-specific knowledge encoded within the management framework.

Existing techniques for encoding domain knowledge generally fall into two extremities: (1) White-box approaches where the system-designer defines detailed formulas or rules to describe the characteristics of the system. These techniques are generally limited by excessive complexity and brittleness of the domain knowledge to ongoing changes in the system. (2) Black-box approaches' where the system acquires domain-specific knowledge by monitoring the system behavior and using machine learning techniques. However, this approach tends to be error-prone, and generally requires an infeasible number of iterations for converging in real-world multi-parameter systems.

Encoding of the domain-specific knowledge has been an active area of research within expert systems. In system management, the White-box approach for creating domain knowledge is manifested as Event-Condition-Action (ECA) rules that define the system behavior in different system states. These rules serve as “canned recipes” for automated management; i.e., at runtime, the management software simply determines the rule that is applicable in the current state, and invokes it. Similarly, the Black-box approach is mainly manifested as Case-Based Reasoning (CBR), where the management software determines the action to be invoked by scanning a history of previous system states that are similar to the current state. In view of the foregoing, there remains a need for a novel domain knowledge encoding technique that overcomes these issues of complexity, brittleness, and accuracy.

### SUMMARY OF THE INVENTION

In view of the foregoing, an embodiment of the invention provides a system for creating the domain knowledge-base models required for automated system management, wherein the system comprises data storage system designer specifications comprising input/output parameters; a first processor adapted to collect a runtime system performance log of a data storage system; a second processor adapted to identify relationship functions between different ones of the input/output parameters; knowledge-base models derived from the designer specifications, the runtime system performance log, and the relationship functions; and a third processor adapted to use the system performance log to refine the knowledge-base models at system runtime and to improve the accuracy of the knowledge-base models by detecting incomplete designer specifications. Preferably, the knowledge-base models are generated by data mining techniques.

The knowledge-base models may comprise mathematical functions that capture details of the data storage system required for deciding corrective actions at system runtime, wherein the knowledge-base models may comprise a model adapted for a response time of an individual component of the data storage system as a function of incoming load at the component, wherein the response time is dependent on a service-time and wait-time incurred by a workload stream of the data storage system. The knowledge-base models may comprise a load on an individual component in an invocation path of a system workload of the data storage system, wherein a prediction is made of the load on each the component as a function of a request rate that each workload injects into the data storage system. Additionally, the knowledge-base models may comprise a cost and benefit of an action invocation of the data storage system. Preferably, the data storage system designer specifications comprise an action model subset of invocation parameters, workload characteristics, and set-up parameters that have a correlation in the knowledge-base models; and a nature of correlation between different ones of the knowledge-base models, wherein the nature of correlation comprise any of linear, quadratic, polynomial, and exponential functions. Preferably, the incomplete designer specifications comprise designer specified specifications missing all relevant input parameters that affect an output parameter being modeled.

Another embodiment of the invention provides a method of creating domain knowledge-base models required for automated system management, and a program storage device for performing the method of creating domain knowledge-base models, wherein the method comprises defining data storage system designer specifications comprising input/output parameters; analyzing a runtime system performance log of a data storage system; identifying relationship functions between different ones of the input/output parameters; deriving knowledge-base models from the designer specifications, the runtime system performance log, and the relationship functions; refining the knowledge-base models at system runtime using newly monitored system performance logs; and improving the accuracy of the knowledge-base models by detecting incomplete designer specifications, wherein the knowledge-base models are preferably generated by data mining techniques.

The knowledge-base models may comprise mathematical functions that capture details of the data storage system required for deciding corrective actions at system runtime. The knowledge-base models may comprise a model adapted for a response time of an individual component of the data storage system as a function of incoming load at the component, wherein the response time is dependent on a service-time and wait-time incurred by a workload stream of the data storage system. The knowledge-base models may comprise a load on an individual component in an invocation path of a system workload of the data storage system, wherein a prediction is made of the load on each the component as a function of a request rate that each workload injects into the data storage system. The knowledge-base models may comprise a cost and benefit of an action invocation of the data storage system. Preferably, the data storage system designer specifications comprise an action model subset of invocation parameters, workload characteristics, and set-up parameters that have a correlation in the knowledge-base models; and a nature of correlation between different ones of the knowledge-base models, wherein the nature of correlation comprise any of linear, quadratic, polynomial, and exponential functions. Preferably, the incomplete designer specifications comprise designer specified specifications missing all relevant input parameters that affect an output parameter being modeled.

These and other aspects of the embodiments of the invention will be better appreciated and understood when considered in conjunction with the following description and the accompanying drawings. It should be understood, however, that the following descriptions, while indicating preferred embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 illustrates the mapping of data set of workloads to available resources according to an embodiment of the invention;

FIG. 2 illustrates a procedure of deriving action and component functions according to an embodiment of the invention;

FIG. 3 illustrates the specifications for the migration action according to an embodiment of the invention;

FIG. 4 illustrates the schema of the database of monitored information according to an embodiment of the invention;

FIG. 5 illustrates an adaptive learning of neural networks according to an embodiment of the invention;

FIG. 6 illustrates an incomplete component specification according to an embodiment of the invention;

FIG. 7 illustrates a graphical representation of IOPS vs. num_thread according to an embodiment of the invention;

FIGS. 8(a) and 8(b) illustrate graphical representations of IOPS vs. num_thread by fixing the values of other parameters such as RW_ratio and SR_ratio according to an embodiment of the invention;

FIG. 9 illustrates component specifications where all relevant parameters are specified according to an embodiment of the invention;

FIGS. 10(a) and 10(b) illustrate graphical representations of accuracy and runtime of batch learning and adaptive learning according to an embodiment of the invention;

FIG. 11 illustrates a flow diagram of a preferred method according to an embodiment of the invention;

FIG. 12 is a schematic diagram of a computer system according to an embodiment of the invention; and

FIG. 13 is a schematic diagram of a system according to an embodiment of the invention.

### DETAILED DESCRIPTION OF PREFERRED EMBODIMENTS OF THE INVENTION

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

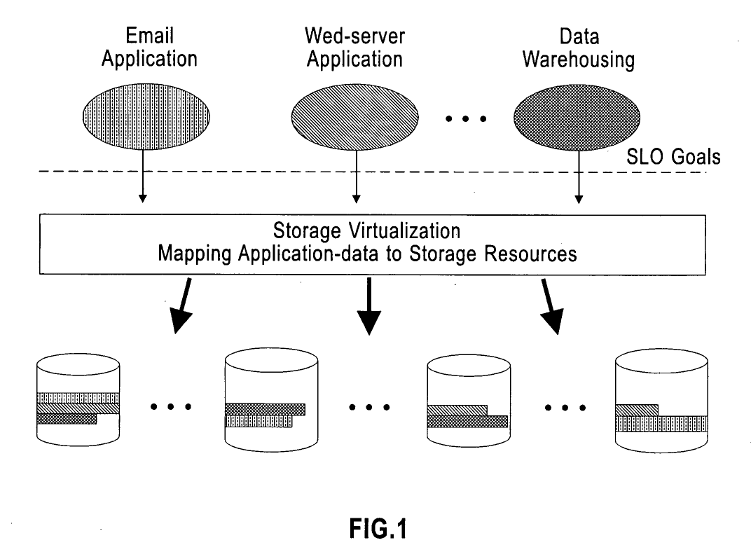

As mentioned, there remains a need for a novel domain knowledge encoding technique that overcomes these issues of complexity, brittleness, and accuracy. The embodiments of the invention achieve this by providing a Gray-box domain knowledge encoding technique called “MonitorMining” that uses a combination of simple system-designer specifications with the information gathered using machine learning. Referring now to the drawings and more particularly to FIGS. 1 through 13 where similar reference characters denote corresponding features consistently throughout the figures, there are shown preferred embodiments of the invention.

The embodiments of the invention provide a technique for building domain knowledge. The domain knowledge comprises mathematical functions (referred to as models). For each of these models, the designer specifications list the domain-specific input parameters, while regression techniques such as neural networks, support vector machines, etc. are used to deduce the exact mathematical function that correlates these parameters. These functions are continuously refined at system runtime by periodically applying regression to the newly monitored data. The advantages afforded by the embodiments of the invention include simplistic designer-defined specifications, non-brittleness, and faster convergence of the deduced functions by limiting the number of parameters considered for regression. The embodiments of the invention achieve these advantages by providing a model-based representation of the domain knowledge for automated storage management; a technique to create and evolve the domain knowledge using a “gray-box” approach; and an off-the-shelf technique to cater incomplete designer specifications.

Table 1 defines the management terminology used in accordance with the embodiments of the invention.

TABLE 1
System Management Terminology

| Term | Description |
|---|---|
| Service | Defines the desired threshold values for the system's performance, |
| Level | reliability, security, availability. The embodiments of the invention |
| Objectives | supports performance SLOs. A performance SLO is of the form: |
| (SLO) | throughput-threshold@latency-threshold; i.e., a request-rate below the |
| | throughput-threshold should have the average response-time below the |
| | latency-threshold. |
| Workload | There are multiple applications (such as web-server, e-mail) running on the |
| | system; the input/output (I/O) requests generated by each application are |
| | referred to as workload. Workload characteristics refer to I/O access |
| | characteristics namely request rate, average request size, read/write ratio, |
| | sequential/random access pattern. The data accessed by the workload is |
| | referred to as the data-set |
| Corrective | Changes the behavior of the system so that it converges towards |
| Actions | administrator-defined goals. Actions are categorized into: Short-term |
| | actions that tune the system without physical movement of data, and can |
| | take into effect immediately; e.g. data-prefetching, throttling, etc. Long- |
| | term actions generally involve physical movement of data, and have a non- |
| | negligible transient cost e.g. data-migration, replication. |
| Invocation | The series of components in the system that are used for servicing the |
| Path | workload requests. |

FIG. 1 shows a production storage system with multiple applications (such as e-mail, database, web-server) using the storage resources. Each application can have different access characteristics, priorities, and SLOs. The task of a storage virtualization engine (such as SAN.FS and SAN Volume Controller) is to map the application-data to the available storage resources. A one-time mapping of data to resources is not optimal and not feasible in most scenarios because of incomplete initial information of the access characteristics, component failures, and load surges that occur at runtime. Thus, there is a need for automated system management to continuously observe, analyze, and act by invoking corrective actions such as throttling, pre-fetching, data replication, etc. Accordingly, the embodiments of the invention address these needs as further described below.

A management framework invokes corrective actions to minimize the effect of system events such as workload variations, component failures, and load surges, on the SLOs of workloads running in the system. Building the action selection function is non-trivial as it needs to take into account: (1) the cost-benefit of actions that is dependent on the system state and the parameters values used for action invocation; (2) the workload trends and load pattern on the system that might make a few actions infeasible in a given state; thus there is no universal “rule-of-thumb” for invoking actions; (3) there are a large number of possible system states (it is generally impossible to write policy rules for selecting actions in every possible system state), and the need to adapt to changes in the system such as addition of new components and new application workloads.

A model-based approach, such as the one provided by an embodiment of the invention, for automated system management that makes decisions using prediction functions for the behavior of the system for given load characteristics and configuration parameters. The key challenges with this approach are the representation of domain-specific details as prediction functions or models, creation of these models, and using the models at runtime to decide the corrective actions. Accordingly, the embodiments of the invention provide a framework for the representation and creation of self-evolving models.

The domain knowledge comprises mathematical functions (i.e., models) that capture the system details required for deciding corrective actions at runtime. In the case of storage systems, the domain knowledge comprises models for: (1) the response time of the component as a function of incoming load at the component (component model); (2) the load on the individual components in the workload's invocation path (workload model); and (3) the cost and benefit of action invocation (action model). Each of these models is further described below.

A component model predicts the response time of the component as a function of the incoming load at the component. The component's response time is dependent on the service-time and wait-time incurred by the workload stream. The service time is a function of the workload characteristics and is of the form:
Stime_{Wi}=c(req_size, req_rate, rw_ratio, random/sequential, cache_hit_rate . . . )
The wait time represents the time spent in the queue due to interleaving with other workload streams arriving at the component. The embodiments of the invention approximate this non-trivial computation by estimating the wait time for each individual stream as per a multi-class queuing model. The resultant response time is approximated as follows. The utilization, U, of the component is:

$$Utilization ( U ) = {\sum }_{i = 1}^{n} {λ}_{Wi} {Stime}_{Wi}$$

where λ_{Wi} is the arrival rate and Stime_{Wi} is the service-time for the workload stream Wi. The resultant response time Rtime of the component for the workload stream Wi is represented as:

$${Rtime}_{Wi} = \frac{{Stime}_{Wi}}{1 - U}$$

According to the embodiments of the invention, workload models predict the load on each component as a function of the request rate that each workload injects into the system. For example, to predict the rate of requests at component i originated by workloadj:
Component_loadᵢⱼ=wᵢⱼ (workload_request_rateⱼ)
In real-world scenarios, function wᵢⱼ changes continuously as workload j changes or other workloads change their access patterns (e.g., a workload with good temporal locality will push other workloads off the cache). To account for these effects, the embodiments of the invention represent function wᵢⱼ as a moving average that gets recomputed by regression every n sampling periods.

An action model captures the transient costs and expected benefit of invoking the action. These effects are a function of the current system state and the values of the invocation parameters. The effect of invoking the action is represented as a change in one of the following:

(1) Component models; e.g., data prefetching improves the response-time of the component for sequential workloads, and is represented as a change in the component model.

(2) Workload models; e.g., migration of data reduces the workload's dependency on the current component as data is moved to the new component; this is represented as a change in the workload model.

(3) Workload access characteristics; e.g., the throttling action is represented as a change in the workload request rate.

In the examples described above, throttling and data prefetching generally have a negligible transient cost. However, actions such as migration incur the transient cost of reading data from the source and writing it to the target. Both the transient cost as well as the permanent benefit function is represented in terms of a workload model; the transient cost is formalized as an additional workload stream on the source and target component.

The functions for the component, workload, and action models can potentially include a large number of parameters. For example, in the case of migration action, the monitoring infrastructure will collect detailed state information (order of hundreds of parameters) from individual components in the invocation path. A pure black-box approach will generally try to find a function that relates all of them and will generally be quite inaccurate. On the other hand, the white-box approach will generally define the exact function between the relevant subset of parameters, but will generally be complex to define and will tend to be brittle to the system changes.

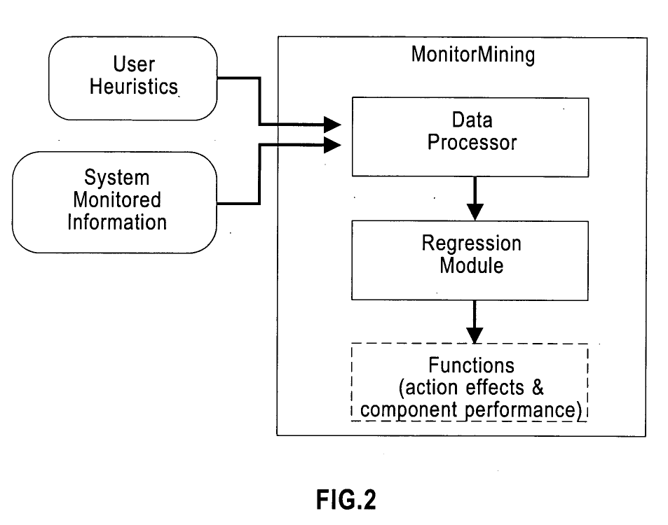

Accordingly, the embodiments of the invention provide a hybrid approach where the designer defines a list of correlated parameters along with a hint of the nature of relationship (as shown in FIG. 2), while data regression techniques are used to deduce the function. The intuition of the technique provided by the embodiments of the invention is that the list of correlated parameters is dependent on the actual implementation and is non-brittle with respect to the underlying physical infrastructure, while the coefficients of the parameter functions are brittle and are evolved at runtime.

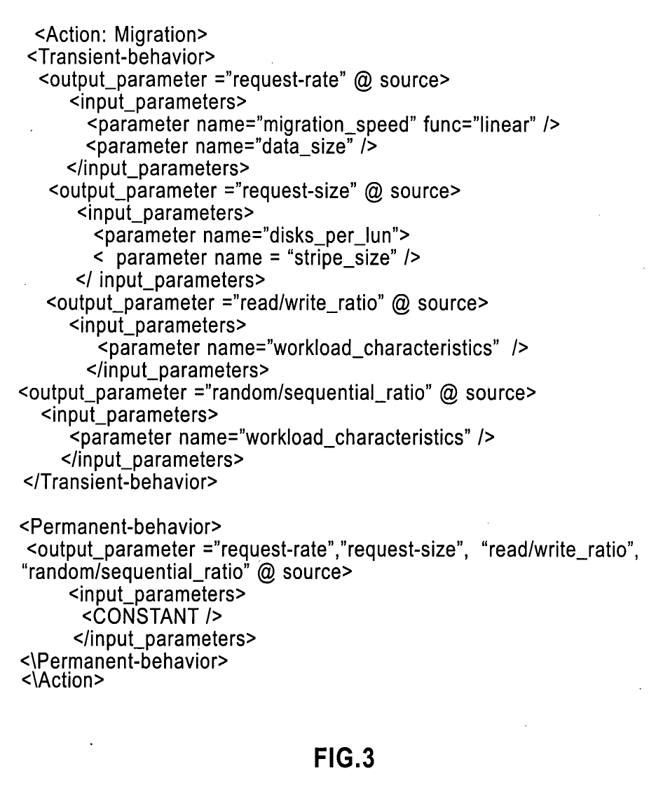

The designer-specifications enumerate a list of related input-output parameters for the action, component, and workload models; e.g. “Parameter X is related to the target Parameter Y.” Additionally, the specifications can have an optional hint for the type of relationship; e.g. “There is a quadratic relationship between Parameter X and Parameter Y.” FIG. 3 gives example specifications for the migration action.

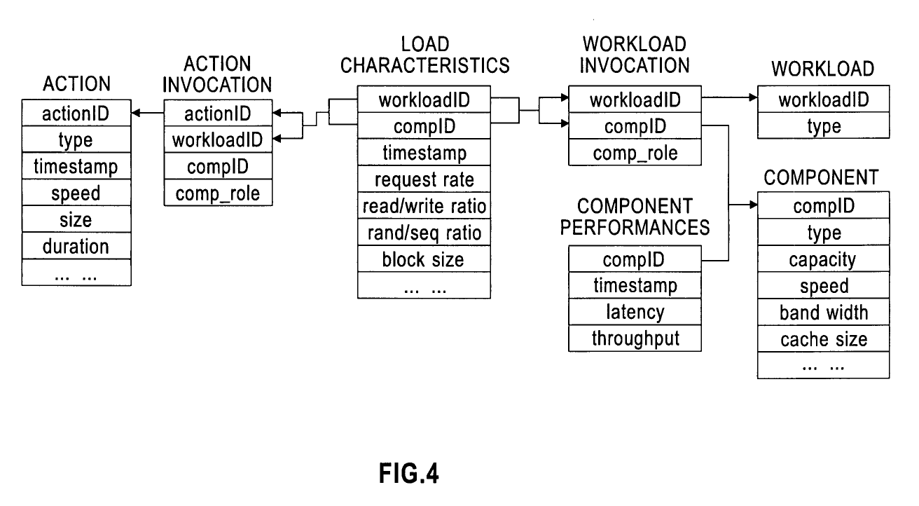

Using the designer specifications, the embodiments of the invention analyze the performance log to derive the models. The schema for the performance logs is shown in FIG. 4. The parameters short-listed by the designer-specifications are extracted from the performance log and fed to the regression algorithms. The embodiments of the invention implement two approaches for regression: (1) Support Vector Regression (SVR) that is relatively easy to implement, and (2) a neural network with back-propagation.

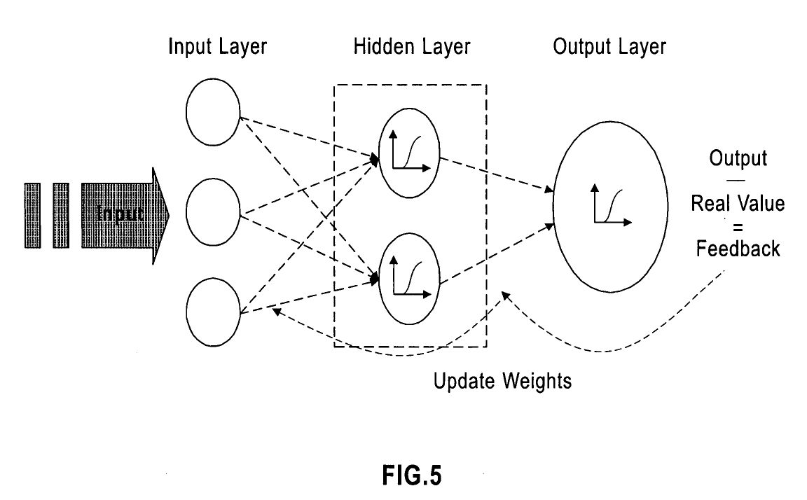

One of the key ideas of SVR is to find the balance point between the training error and the complexity of the function. In other words, it avoids finding complex functions with low error only on training data but high error on real world data. SVR is able to identify linear functions, polynomial functions, and functions of arbitrary shapes as directed by user. However, this technique is usually inefficient for large datasets. Neural networks can find functions of arbitrary shapes by adapting its network structure with the data. This technique is generally efficient and can perform reinforcement learning to adapt to changing environments. The structure of a neural network as implemented by an embodiment of the invention is shown in FIG. 5. A neural network generally includes an input layer, one or more hidden layers, and an output layer.

The embodiments of the invention use a brute force approach to determine the function (in case the designer specifications do not specify them). This approach applies different function forms to the data and chooses one with the “best-fit.” The list of candidate functions used are: (1) linear (x); (2) quadratic (x²+ax); (3) power (x^{a}); (4) reciprocal (1/x); (5) logarithm (ln(x)); (6) exponential (a^{x}); and (7) simple combinations of two of these, such as reciprocal linear (1/(x+a)).

Generally, neural networks and support vector machines can both identify functions of arbitrary shapes. However, they usually have better performances when the data can be well modeled by some simple models. Preferably, the time complexity for neural networks should be linear to the data size (but usually it will iterate many rounds for optimization). Preferably, the time complexity for support vector machines is quadratic with respect to the number of data points.

The initial baseline values for the action, workload, and component models are generated as follows:

(1) Component models: The initial values are preferably generated either from the component's performance specifications provided by the vendor, or by running calibration tests and measuring the component's behavior for different permutations of workload characteristics. The calibration tests generate I/O requests with different permutation of <request size, read write size, random sequential ratio, num threads>. For each of the I/O permutations, the iops, wait-time, and service-time counters are collected from the component.

(2) Action models: The effect of action is mainly dependent on the implementation details of the actions rather than the deployment specific details. As such, the baseline values for the action models can be pre-packaged by running in-house experiments to invoke the action for different workload characteristics and invocation parameter values.

(3) Workload models: The initial values of the workload models are based on libraries of workload characteristics for different applications such as e-mail, web-server, online-transactions, etc.

These models are continuously updated. This improves the accuracy of the regression functions (increasing the number of data-points that have been seen in the past), and also accounts for changes in the system (especially the workload models). Evolving models using neural networks is based on the difference between the predicted value and the actual monitored value. This difference is used for back propagation; i.e., change the link weights between units of different layers. The embodiments of the invention utilize two approaches to evolve the models: (1) a computationally efficient approach is to invoke regression after every m additional data-points are collected from the system. This approach is used for the component and action models as they are relatively static compared to the workload models. (2) Another approach is to update the model after every prediction. In this approach, the difference between the predicted value and the actual value is used as an error-feedback to adjust the coefficient values in the model using re-enforcement based neural networks. The experimental section compares results of both these approaches.

In practice, a system designer may not necessarily provide a complete set of relevant parameters. Missing parameters lead to inaccuracy of the models and reflect as larger differences between the predicted value and the actual value. A data mining approach such as Iceberg Cubing™ may be used for this purpose. The approach can be formally stated as: Given a set of records with K parameters x₁, . . . , x_{K} and a target value y, find all groups of at least m records that have identical or similar values on at least K=δ parameters (δ=1 or 2). Two values v₁, v₂ of parameter xₖ are said to be similar to each other if v₁−v₂≦ε range(xₖ). According to the embodiments of the invention, m is set to be equal to 5.

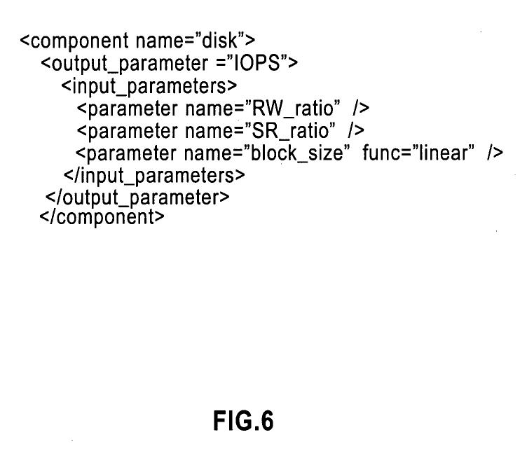

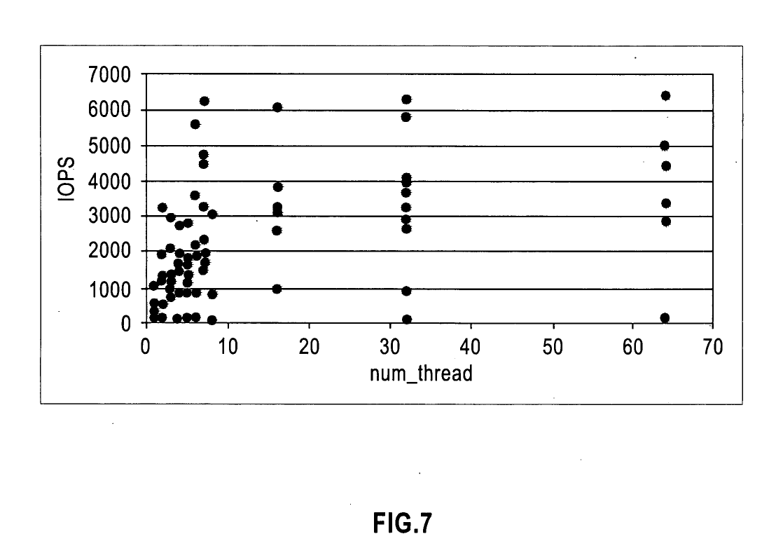

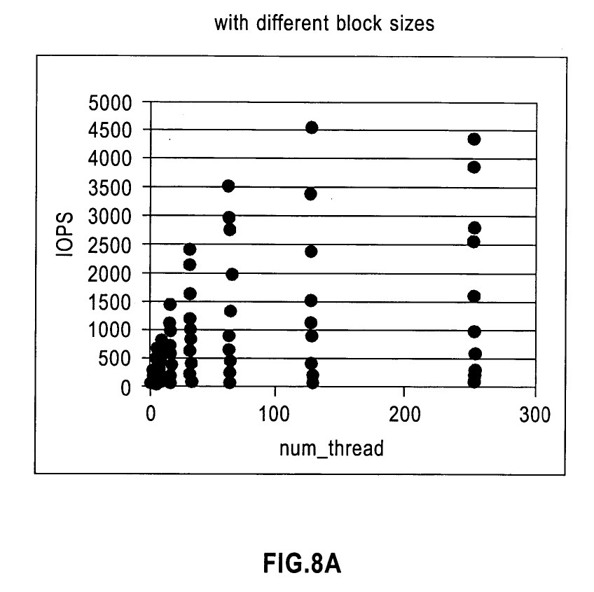

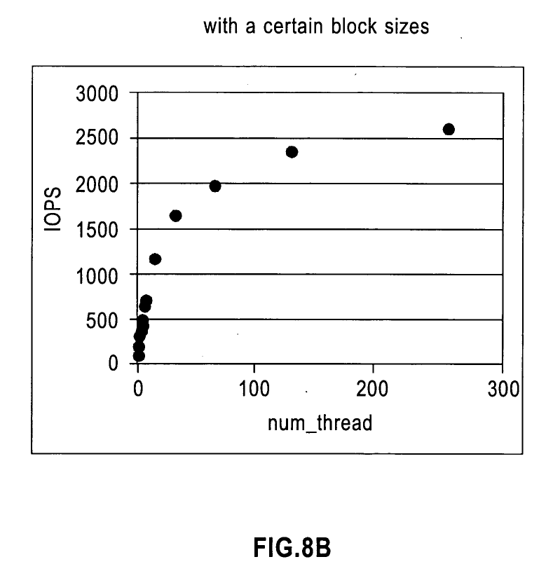

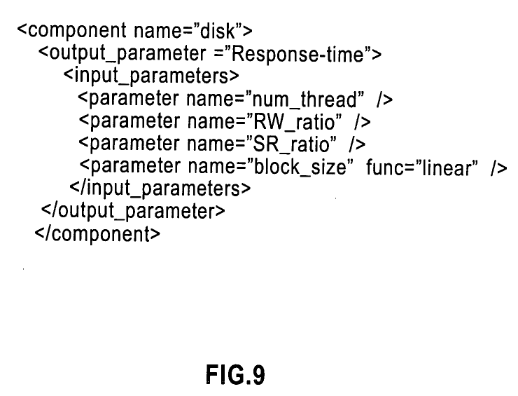

To illustrate this, consider the designer-specifications as shown in FIGS. 6 and 9. In these specifications, num_threads is not specified as a relevant parameter. The embodiments of the invention utilize Bottom-Up Computation (BUC) as an Iceberg Cubing algorithm, and its internal working is described as follows. 100 records are randomly selected and plotted as shown in FIG. 7. It is difficult to determine whether num_thread and IOPS (output parameter) are related, when the effects of three other parameters are present. As such, in order to identify the relationship between num_thread and IOPS, BUC finds all the records with a certain RW (read/write) ratio and SR (sequential/random) (but different block size), and plots them as shown in FIG. 8(a). From this plot it is clear that num_thread and IOPS are related, but it is still difficult to find how they are related. In FIG. 8(b), BUC plots records with identical values on all parameters except num_thread, and it becomes obvious that IOPS is a sub-linear function of num_thread; regression techniques can be used to the exact function.

The current set of experiments serves as a partial proof-of-concept for the technique provided by the embodiments of the invention. In these experiments, the embodiments of the invention are used to create the component model for a 30-drive RAID 0 Logical Volume running on an IBM™ FAStT 900 storage controller. The performance logs comprise 3168 data-points, each of which has four parameters (number of threads, read/write ratio, sequential/random ratio, and block size) and two target values (IOPS and latency). The regression calculations are performed on a P4 2.8 GHz workstation with 512 MB main memory, running Microsoft Windows XP Professional™ operating system. The regression algorithms used in the embodiments of the invention were SVM-light™ for support vector regression, and a version of Neural Networks implemented by CMU. In each of the experiments, the data-points are divided into five parts; four parts are used for training the regression algorithms and one part for testing the accuracy of the functions.

In this experiment, the technique provided by embodiments of the invention is given the designer specifications as shown in FIG. 9. Using the monitored data-points, the embodiments of the invention identify the relationship functions between the individual parameters, and the composite function that relates the target value with all the input parameters. The results are summarized in Table 2.

TABLE 2
Predicting component models for complete designer-specifications

| | SVR | Neural Networks |
|---|---|---|
| Average error | 0.393 | 0.159 |
| Median error | 0.352 | 0.121 |
| Runtime (sec) | 360 | 1.80 |

For this experiment, a data-set is created in which some aspects of component behavior are made to change over time. The current data-points are divided according to their sequential/random ratios. They are divided into six partitions in this way, each having a certain sequential/random ratio (0, 0.2, . . . , 1). Then, a partition is randomly chosen, and a random number (0 to 400, uniformly distributed) is drawn of records from that partition and added to a new dataset. This is repeated until all records are added. If there are not enough records in a partition, all remaining records are added. Then, the parameter of sequential/random ratio is removed from the new dataset. In general, this dataset can be considered to include records of different workloads, each having different sequential/random ratio. A good adaptive learning method should be able to adapt itself according to the changes of the component behavior.

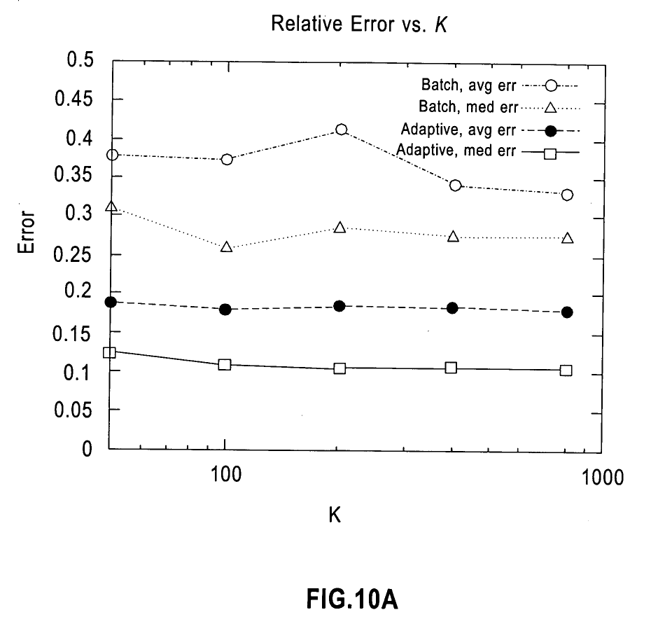

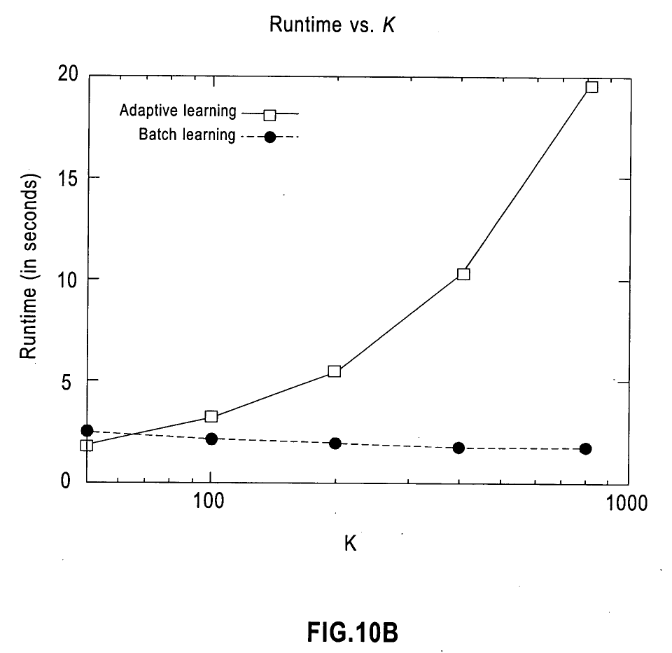

The average error and median error with static learning (i.e., models created in testing phase that are not refined) is determined to be 0.203 and 0.174 respectively. In the batch mode learning in which the model is re-generated after every K records, K=50,100, 200, 400, 800. Similarly, in the adaptive learning mode, the neural network continuously refines the weights using back propagation. The accuracy and running time of the two experiments are shown in FIGS. 10(a) and 10(b). From the experimental results, it is demonstrated that the adaptive learning techniques achieve the highest accuracy (higher than batch learning and static learning). This is because it keeps adapting the model to new data when the component changes its behavior. It is quite efficient when K≦200 and its accuracy does not improve for larger values of K.

The gray-box approach as provided by the embodiments of the invention is new to the domain of system management. Model-based system management as provided by the embodiments of the invention is one of the promising approaches to automated system management. In a model-based approach, the management decisions are based on predictions for the behavior of the system, given the load characteristics and configuration parameters. Some of the features for applying the model-based approach in real-world scenarios are: (1) models need to simple yet semantically rich for making decisions; (2) models should be easy to maintain, and update for changes in the system properties; (3) techniques to handle bootstrapping for the models; evolving the models at runtime when additional monitoring information is collected; and ability to discover missing system parameters on which the model is dependent. Generally, conventional model-based frameworks have a limited scope and have not been applied comprehensively to the domain of runtime system management.

Accordingly, the embodiments of the invention address the issues related with representation, creation, and evolution of models for automated system management and are embodied as a gray-box approach for creating models, where it combines designer specifications with the information generated using machine learning techniques.

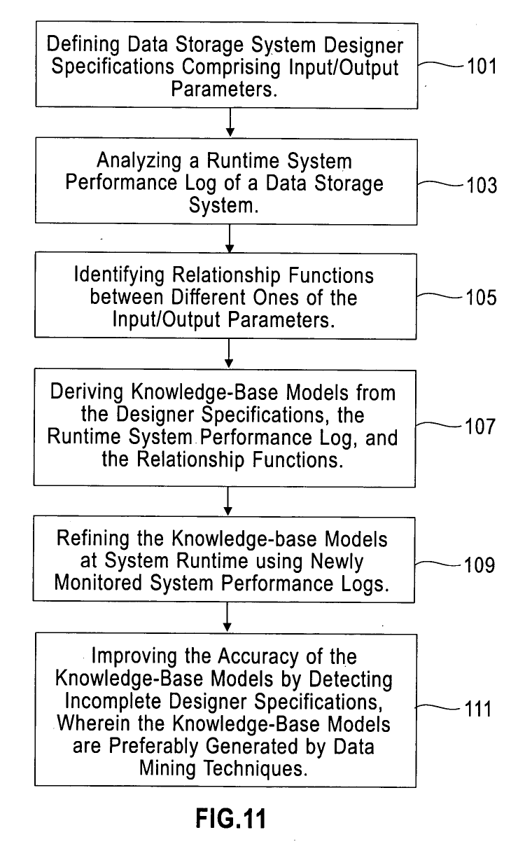

FIG. 11 illustrates a method of creating domain knowledge-base models required for automated system management, wherein the method comprises defining (101) data storage system designer specifications comprising input/output parameters; analyzing (103) a runtime system performance log of a data storage system; identifying (105) relationship functions between different ones of the input/output parameters; deriving (107) knowledge-base models from the designer specifications, the runtime system performance log, and the relationship functions; refining (109) the knowledge-base models at system runtime using newly monitored system performance logs; and improving (111) the accuracy of the knowledge-base models by detecting incomplete designer specifications, wherein the knowledge-base models are preferably generated by data mining techniques.

The knowledge-base models may comprise mathematical functions that capture details of the data storage system required for deciding corrective actions at system runtime. The knowledge-base models may comprise a model adapted for a response time of an individual component of the data storage system as a function of incoming load at the component, wherein the response time is dependent on a service-time and wait-time incurred by a workload stream of the data storage system. The knowledge-base models may comprise a load on an individual component in an invocation path of a system workload of the data storage system, wherein a prediction is made of the load on each the component as a function of a request rate that each workload injects into the data storage system. The knowledge-base models may comprise a cost and benefit of an action invocation of the data storage system. Preferably, the data storage system designer specifications comprise an action model subset of invocation parameters, workload characteristics, and set-up parameters that have a correlation in the knowledge-base models; and a nature of correlation between different ones of the knowledge-base models, wherein the nature of correlation comprise any of linear, quadratic, polynomial, and exponential functions. Preferably, the incomplete designer specifications comprise designer specified specifications missing all relevant input parameters that affect an output parameter being modeled.

The embodiments of the invention can take the form of an entirely hardware embodiment, an entirely software embodiment or an embodiment including both hardware and software elements. In a preferred embodiment, the invention is implemented in software, which includes but is not limited to firmware, resident software, microcode, etc.

Furthermore, the embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk−read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

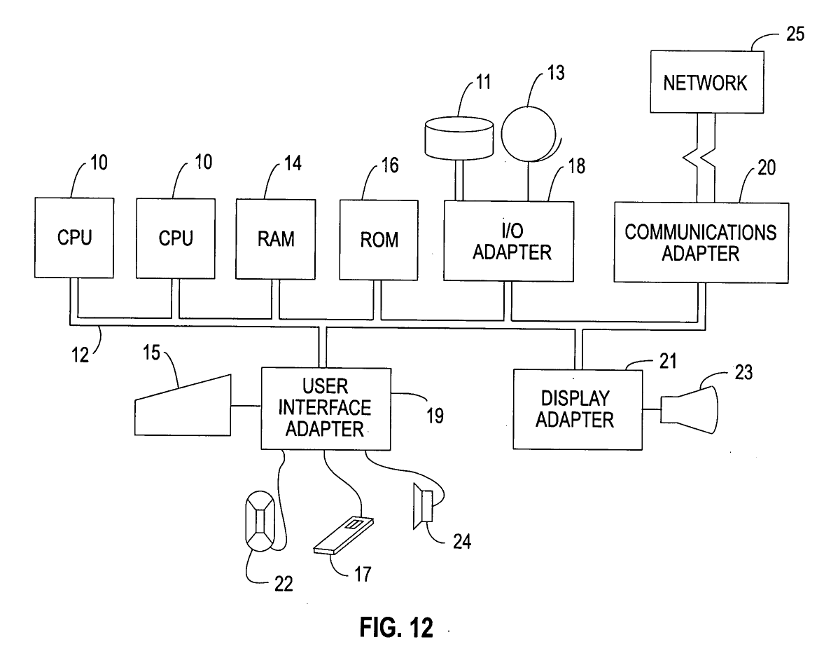

A representative hardware environment for practicing the embodiments of the invention is depicted in FIG. 12. This schematic drawing illustrates a hardware configuration of an information handling/computer system in accordance with the embodiments of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

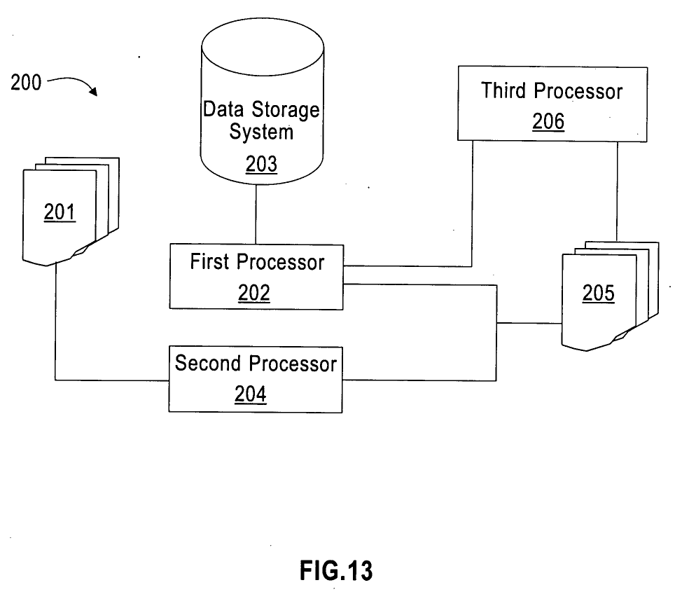

Generally, as illustrated in FIG. 13, the embodiments of the invention provide a system 200 for creating the domain knowledge-base models required for automated system management, wherein the system 200 comprises data storage system designer specifications 201 comprising input/output parameters; a first processor 202 adapted to collect a runtime system performance log of a data storage system 203; a second processor 204 adapted to identify relationship functions between different ones of the input/output parameters; knowledge-base models 205 derived from the designer specifications, the runtime system performance log, and the relationship functions; and a third processor 206 adapted to use the system performance log to refine the knowledge-base models 205 at system runtime and to improve the accuracy of the knowledge-base models 205 by detecting incomplete designer specifications.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

What is claimed is:

1. A system for creating the domain knowledge-base models required for automated system management, said system comprising:
data storage system designer specifications comprising input/output parameters;
a first processor adapted to collect a runtime system performance log of a data storage system;
a second processor adapted to identify relationship finctions between different ones of said input/output parameters;
knowledge-base models derived from said designer specifications, said runtime system performance log, and said relationship functions; and
a third processor adapted to use said system performance log to refine said knowledge-base models at system runtime and to improve the accuracy of said knowledge-base models by detecting incomplete designer specifications.

2. The system of claim 1, wherein said knowledge-base models are generated by data mining techniques.

3. The system of claim 1, wherein said knowledge-base models comprise mathematical functions that capture details of said data storage system required for deciding corrective actions at system runtime.

4. The system of claim 3, wherein said knowledge-base models comprise a model adapted for a response time of an individual component of said data storage system as a function of incoming load at said component, wherein said response time is dependent on a service-time and wait-time incurred by a workload stream of said data storage system.

5. The system of claim 3, wherein said knowledge-base models comprise a load on an individual component in an invocation path of a system workload of said data storage system, wherein a prediction is made of the load on each said component as a function of a request rate that each workload injects into said data storage system.

6. The system of claim 3, wherein said knowledge-base models comprise a cost and benefit of an action invocation of said data storage system.

7. The system of claim 3, wherein said data storage system designer specifications comprise:
an action model subset of invocation parameters, workload characteristics, and set-up parameters that have a correlation in said knowledge-base models; and
a nature of correlation between different ones of said knowledge-base models, wherein said nature of correlation comprise any of linear, quadratic, polynomial, and exponential functions.

8. The system of claim 1, wherein said incomplete designer specifications comprise designer specified specifications missing all relevant input parameters that affect an output parameter being modeled.

9. A method of creating domain knowledge-base models required for automated system management, said method comprising:
defining data storage system designer specifications comprising input/output parameters;
analyzing a runtime system performance log of a data storage system;
identifying relationship functions between different ones of said input/output parameters;
deriving knowledge-base models from said designer specifications, said runtime system performance log, and said relationship functions;
refining said knowledge-base models at system runtime using newly monitored system performance logs; and
improving the accuracy of said knowledge-base models by detecting incomplete designer specifications.

10. The method of claim 9, wherein said knowledge-base models are generated by data mining techniques.

11. The method of claim 9, wherein said knowledge-base models comprise mathematical functions that capture details of said data storage system required for deciding corrective actions at system runtime.

12. The method of claim 11, wherein said knowledge-base models comprise a model adapted for a response time of an individual component of said data storage system as a function of incoming load at said component, wherein said response time is dependent on a service-time and wait-time incurred by a workload stream of said data storage system.

13. The method of claim 11, wherein said knowledge-base models comprise a load on an individual component in an invocation path of a system workload of said data storage system, wherein a prediction is made of the load on each said component as a function of a request rate that each workload injects into said data storage system.

14. The method of claim 11, wherein said knowledge-base models comprise a cost and benefit of an action invocation of said data storage system.

15. The method of claim 11, wherein said data storage system designer specifications comprise:
an action model subset of invocation parameters, workload characteristics, and set-up parameters that have a correlation in said knowledge-base models; and
a nature of correlation between different ones of said knowledge-base models, wherein said nature of correlation comprise any of linear, quadratic, polynomial, and exponential functions.

16. The method of claim 9, wherein said incomplete designer specifications comprise designer specified specifications missing all relevant input parameters that affect an output parameter being modeled.

17. A program storage device readable by computer, tangibly embodying a program of instructions executable by said computer to perform a method of creating domain knowledge-base models required for automated system management, said method comprising:
defining data storage system designer specifications comprising input/output parameters;
analyzing a runtime system performance log of a data storage system;
identifying relationship functions between different ones of said input/output parameters;
deriving knowledge-base models from said designer specifications, said runtime system performance log, and said relationship functions;
refining said knowledge-base models at system runtime using newly monitored system performance logs; and
improving the accuracy of said knowledge-base models by detecting incomplete designer specifications.

18. The program storage device of claim 17, wherein said knowledge-base models are generated by data mining techniques.

19. The program storage device of claim 17, wherein said knowledge-base models comprise mathematical functions that capture details of said data storage system required for deciding corrective actions at system runtime.

20. The program storage device of claim 19, wherein said knowledge-base models comprise a model adapted for a response time of an individual component of said data storage system as a function of incoming load at said component, wherein said response time is dependent on a service-time and wait-time incurred by a workload stream of said data storage system.

21. The program storage device of claim 19, wherein said knowledge-base models comprise a load on an individual component in an invocation path of a system workload of said data storage system, wherein a prediction is made of the load on each said component as a function of a request rate that each workload injects into said data storage system.

22. The program storage device of claim 19, wherein said knowledge-base models comprise a cost and benefit of an action invocation of said data storage system.

23. The program storage device of claim 19, wherein said data storage system designer specifications comprise:
an action model subset of invocation parameters, workload characteristics, and set-up parameters that have a correlation in said knowledge-base models; and
a nature of correlation between different ones of said knowledge-base models, wherein said nature of correlation comprise any of linear, quadratic, polynomial, and exponential functions.

24. The program storage device of claim 17, wherein said incomplete designer specifications comprise designer specified specifications missing all relevant input parameters that affect an output parameter being modeled.
